(19) United States
(12) Patent Application Publication
(10) Pub. No.: US 2002/0086071 A1
(43) Pub. Date: Jul. 4, 2002

(54) Extrusion head for extruding a tube-shaped strand from at least one thermoplastic melt for producing blown films

(76) Inventor: Anton Rubhausen, Niederkassel (DE)

Correspondence Address: Pauley Petersen Kinne & Erickson, 2800 W. Higgins Road, Suite 365, Hoffman Estates, IL, 60195, US

(21) Appl. No.: 09/997,403

(22) Filed: Nov. 29, 2001

(30) Foreign Application Priority Data
Nov. 29, 2000 (DE) 100 59 306.2

(51) Int. Cl. B29C 47/06

(52) U.S. Cl. 425/72.1; 425/133.1

(57) ABSTRACT

An extrusion head for extruding a tube-shaped strand from at least one thermoplastic melt for producing blown films, containing an internal member and an external member, between which an annular space is formed. The external member has at least one extrusion module with two extrusion members, which are arranged on top of each other. A separating gap, which terminates in the annular space, is formed between the extrusion members of each one of the extrusion modules. A channel system for distributing the plastic melt into the annular space is formed in each extrusion module. The channel system includes an inlet area, a branching area and a spiral area, each of which is located on a separate level, wherein the level of the inlet area is arranged between the level of the branching area and the level of the spiral area, and a group of first connecting channels leads from the inlet area into the branching area, and a group of second connecting channels leads from the branching area to the spiral area.

### BACKGROUND OF THE INVENTION

1. Field of the Invention

This invention relates to an extrusion head with an extrusion die for extruding a tube-shaped strand from at least one thermoplastic melt for producing blown films, wherein the extrusion head has an internal member arranged around a center axis and an external member, and an annular space is formed between the internal member and the external member. The annular space extends concentrically with respect to the center axis and terminates in the extrusion die, and the external member has at least one extrusion module with two extrusion members, which are arranged on top of each other and are ring-shaped and plate-shaped. A separating gap, which terminates in the annular space, is formed between the two extrusion members of each one of the extrusion modules, and each extrusion module has a feed line for a plastic melt and a channel system for distributing the plastic melt as far as into the annular space is formed in each extrusion module.

2. Description of Related Art

A channel system for distributing a plastic melt into an annular space of an extrusion head has an important part in achieving even product quality, because it is intended with the channel system to provide an even distribution of the molten thermoplastic material customarily supplied through a peripheral channel in as even as possible portions into the entire annular space. In this case a distinction is made between so-called vertical spiral coil distributors, wherein there is a channel system for distributing the plastic melt in the axial direction of the extrusion head. Reference is made in this connection to U.S. Pat. No. 4,182,603, for example.

Extrusion heads in accordance with U.S. Pat. No. 4,895,744 and U.S. Pat. No. 5,069,612 are known, wherein the extrusion head is constructed in a module-like manner from several extrusion modules. Each extrusion module has a channel system for distributing the plastic melt provided, which is embodied on conical surfaces extending in the axial direction of the extrusion head toward the annular space.

An extrusion head for producing blown films is known from U.S. Pat. No. 3,809,515, wherein the extrusion head is divided into extrusion modules vertically in relation to its center axis and the channel system for distributing the melt is arranged vertically with respect to the axial direction, wherein the plastic melt is fed centrally in the center axis and from there is distributed into the annular space radially toward the exterior.

An extrusion head for producing a blown film is known from German Patent Reference DE 42 18 095 C2, wherein the channel system inside the extrusion head is embodied on a level extending vertically with respect to the axis of the extrusion head, wherein feeding of the plastic melt takes place from the outside and the plastic melt is distributed moving from the outside toward the inside.

An extrusion head for producing single-layered or multi-layered tubular films is known from French Patent Reference FR 26 25 941, wherein the extrusion head is also divided vertically with respect to its axial direction into a plurality of extrusion modules, each of which has an annular plate. The channel system for distributing the melt is distributed to the individual annular plates of the extrusion head, for example from the feeding of the plastic melt at the circumference of the extrusion head to the entry into the annular space, the channel system, and therefore the plastic melt, passes through five annular plates, which form one extrusion module.

Extrusion heads with several extrusion modules make possible the extrusion of multi-layered tube-shaped strands from different thermoplastic melts, which are thereafter blown to form appropriate multi-layered blown films. A goal is a construction of the extrusion head which is a compact as possible and space-saving and has a multitude of identical parts for embodying the individual extrusion modules for supplying respectively one plastic melt in order to assure low production and operating costs. Another goal is a modular construction of the extrusion members, along with as simple as possible an assembly and disassembly. At the same time as homogeneous and even a distribution as possible of the supplied plastic melt in the channel system of each extrusion module should take place, wherein it is also intended to work thermoplastic melts of different raw materials in one extrusion head, and an even distribution and supply of the melt into the annular space is intended to be assured.

### SUMMARY OF THE INVENTION

It is one object of this invention to provide an extrusion head in accordance with the species which is distinguished by a particularly compact and space-saving embodiment, and which offers an efficient channel system for distributing the plastic melt, which makes possible as even a distribution of the plastic melt as possible over a short distance into the annular space, and thus the even extrusion of different raw materials to form single-layered or multi-layered blown films. The extrusion head is intended to be assembled from as great as possible a number of identical parts, and also from parts which are easy to produce.

To attain this object, the invention proposes the design of an extrusion head having characteristics of described in this specification and in the claims.

The above object is accomplished with an extrusion head having a channel system of each extrusion module which comprises an inlet area, a branching area and a spiral area, wherein the spiral area terminates into the annular space in a ring-shaped distribution surface with a ring-shaped outlet opening. The inlet area, the branching area and the spiral area of the channel system each extend on a separate level, wherein the level of the inlet area extends between the level of the branching area and the level of the spiral area. The channel system of the inlet area is connected with the channel system of the branching area by a first group of connecting channels, which lead from the level of the inlet area to the level of the branching area. The channel system of the branching area is connected with the channel system of the spiral area by a second group of connecting channels leading from the level of the branching area to the level of the spiral area.

For creating the particularly compact and variable modular construction, as well as the even distribution of the plastic melt within the extrusion head, or respectively within each extrusion module, which is one object of this invention, the channel system is divided and an inlet area and a branching area are placed upstream of the spiral area, by which an effective pre-distribution of the plastic melt fed in is already provided. Moreover, all distribution areas of the channel system of an extrusion module of the extrusion head designed in accordance with this invention are arranged on different levels, so that a particularly space-saving design of the extrusion head from a multitude of extrusion modules results, and uniformity of the melt distribution is also achieved.

In accordance with this invention, the plastic melt fed in a manner known per se to an extrusion module of the extrusion head in accordance with this invention initially passes through an inlet area on a mid-level, is transferred from there through a group of first connecting channels to a second level, identified as a branching area and which is a multitude of branching channels, and at the end of the branching channels the plastic melt finally reaches a third level through a group of second connecting channels, in which the spiral channels are arranged, which form the spiral area and cause the even feeding of the molten plastic material into the annular space. Because of the arrangement selected, having a level of the inlet area arranged between the level of the branching area and the level of the spiral area, the plastic melt passes through the group of second connecting channels to the level of the inlet area during its passage from the branching area into the spiral area, so that an extremely compact multiple branching is created.

Each extrusion module of the extrusion head in accordance with this invention is formed from two extrusion members, which are arranged stack-like one above the other and between which a separating gap is formed, which is used for supplying the plastic melt, which was evenly distributed by the channel system, to the annular space. The distribution surface adjoining the spiral area extends along the separating gap toward the annular space.

In accordance with this invention, the channel system is formed only on one extrusion member of each extrusion module. Preferably, the channel system with the inlet area, the branching area, the spiral area and the two groups of connecting channels is embodied in the extrusion member of each extrusion module which is facing away from the extrusion die and is identified as the lower member of the extrusion module. The second extrusion member, identified as the upper member of the extrusion module, is placed on the surface of the lower member of the extrusion module having the spiral area, so that the separating gap is formed. The extrusion members are embodied in a ring shape and a plate shape or disk shape. The spiral area of the channel system is formed in the surface of the lower member of the extrusion module facing the separating gap. The branching area of the channel system is formed in the oppositely located surface, facing away from the separating gap, of the lower member of the extrusion module. The inlet area of the channel system is formed between these surfaces within the lower member of the extrusion module. The three levels of the channel system of this invention in an extrusion module for the even distribution of the plastic melt supplied to the extrusion module are only realized in one extrusion member, for example a component of each one of the extrusion modules, namely the spiral area and the branching area at the upper and underside of the one extrusion member, and the inlet area between these two levels within the same extrusion member.

For forming the flow cross-section for the plastic systems, the channel system of the spiral area is formed by known spiral channels and the channel system of the branching area by branching channels, wherein the spiral channels forming the spiral area and/or the branching channels forming the branching area are cut, for example milled, in the form of grooves into the surfaces of the one extrusion member.

It is more elaborate, though also possible within the scope of this invention, to form the spiral channels of the spiral area on both sides of the spiral level in the surface of the lower member of the extrusion module, as well as complementary in the surface of the adjoining upper member of the extrusion module along the separating gap.

In accordance with a another embodiment of this invention, it is possible to provide the lower member of the extrusion module in which the channel system is embodied with a circumferential annular groove on the surface located opposite the surface having the spiral channels, into which a pre-distribution ring can be inserted. The pre-distribution ring has a surface resting against the groove bottom of the annular groove. The branching area is formed on the surface of the lower member of the extrusion module in the area of the groove bottom of the annular groove. It is thus possible to move the level of the branching area out of the separating gap of two adjoining extrusion modules and to seal it with the pre-distribution ring inserted into the annular groove.

In this case the branching channels forming the branching area are advantageously formed with a part of their cross section in the groove bottom of the annular groove of the lower member of the extrusion module, and with a complementary part in the area of the pre-distribution ring resting against the groove bottom, for example, one half in each one, so that one half of corresponding branching channels of a circular cross section, for example, is respectively formed in the lower member of the extrusion module and in the pre-distribution ring, for appropriately joining together during assembly and closing. It is also possible to form the branching channels exclusively in the lower member of the extrusion module, or exclusively in the pre-distribution ring, and to sealingly close the cross sections of the branching channels by placing the members against each other.

With one embodiment of the extrusion head in accordance with this invention having several extrusion modules arranged on top of each other, the pre-distribution ring inserted into one extrusion member can also advantageously be used as an adapter ring for the extrusion modules to be placed on top of each other. For this purpose, the pre-distribution ring has a greater thickness than would correspond to the depth of the annular groove of the lower member of the extrusion module provided with the channel system, so that the pre-distribution ring protrudes with a portion of its cross section beyond the annular groove in the direction toward the adjoining extrusion module, and the projecting portion of the pre-distribution ring can be fitted into a complementary designed annular groove on the top of the upper member of the extrusion module of an adjoining following extrusion module. It is thus possible to effectively reduce the structural height of the extrusion head in accordance with this invention, even when it has several extrusion modules arranged on top of each other, and at the same time the pre-distribution ring of each extrusion module is arranged and seated exactly within the extrusion head.

The pre-distribution ring can be releasably fastened in the annular groove of the lower member of the extrusion module, for example, it can be screwed into this annular groove using suitable screws, in order to form the branching channels forming the branching area of the lower member of the extrusion module, in particular in an exactly positioned manner.

The inlet area of each extrusion module of the extrusion head in accordance with this invention is advantageously formed by two inlet channels, which are arranged in a V-shape relative to each other and extend from the circumference of the first extrusion member, and respectively lead to a first connecting channel, which provides communication with the branching area. Thus a division of the plastic melt into two portions of equal size is performed in the inlet area formed by the two inlet channels, which portions are transferred through the first connecting channels to the branching area and are further divided there, until finally they are uniformly fed from the spiral area into the annular groove. The arrangement of the inlet channels in such a way that they start at the circumference of the first extrusion member also allows the connection at the circumference of the extrusion installations for producing and feeding of the plastic melt without further structural outlay.

Two branching systems are formed symmetrically with respect to each other, starting at the connecting channels emanating from the inlet channels, and each branching system again branches into four identical branching channels. The eight ends of the four identical branching channels are evenly distributed on a circular ring coaxially with respect to the center axis of the extrusion head, and respectively communicate with a connecting channel leading to the spiral area. Thus the branching area of the extrusion head in accordance with this invention includes, for example, a system of branching channels leading to eight second connecting channels, so that the plastic melt entering via the inlet area, which transitions via the first group of connecting channels into the branching area, is divided into eight partial flows in the branching channels. These eight partial flows enter into the spiral area through the second connecting channels.

The spiral area itself advantageously comprises several spiral channels placed inside each other and extending in a converging manner, which run radially from the outside toward the inside and which communicate at their radially outside located ends with a connecting channel coming from the branching area. In the case of eight communicating channels routed from the eight ends of the branching channels, eight spiral channels are thus advantageously provided. Depending on the size and layout of the extrusion head in accordance with this invention, varying embodiments regarding the number of inlet channels, group of the first connecting channels, branching channels and group of the second connecting channels, as well as spiral channels, are of course possible.

To assure as even as possible a distribution of the plastic melt when it enters into the annular space, the spiral channels have a flow cross section for the plastic melt which decreases from the outside toward the inside, so that the melt is accelerated when flowing toward the annular space.

In a particularly advantageous embodiment of the extrusion head in accordance with this invention, all flow paths for the plastic melt through the channel system in one extrusion module are designed to be of equal length, so that there is an even effect of the channel system on all partial flows of the plastic melt, and in particular a homogeneous temperature and distribution of plastic melt is obtained.

A particularly compact structure of the extrusion head is achieved in accordance with this invention because the levels of the inlet area, the distribution area and the spiral area of one extrusion module are arranged parallel with respect to each other. These levels are advantageously arranged so they extend vertically with respect to the center axis of the extrusion head. It is also possible, according to this invention, to provide different orientations of the levels in relation to the center axis.

A further advantageous construction of the extrusion head of this invention has connecting channels of the first group, which connect the inlet area of the channel system with the branching area of the channel system. The connecting channels of the second group, which connect the branching area of the channel system with the spiral area of the channel system, are embodied to extend vertically with respect to the levels of the channel system and coaxially with respect to the center axis of the extrusion head.

All extrusion modules of the extrusion head in accordance with this invention can be separately heated, so that the plastic melts conducted through these extrusion modules can be discharged within the respectively optimum temperature range, and damaging thermal effects are kept away to a great extent from the plastic melt.

### BRIEF DESCRIPTION OF THE DRAWINGS

This invention is explained in further detail in what follows by means of the drawings, which represent only one exemplary embodiment, wherein:

FIG. 1 is a schematic representation of parts of the device for extruding and producing a blown film;

FIG. 2 is a longitudinal section in a schematic representation taken through a modularly constructed extrusion head in accordance with FIG. 1;

FIG. 3 shows detail W of FIG. 2 in an enlarged representation;

FIG. 4 is a top view on the lower member of an extrusion module in the view in accordance with the arrow D1 shown in FIG. 3;

FIG. 5 is a top view on the lower member of an extrusion module in the view in accordance with the arrow D2 shown in FIG. 3;

FIG. 6 is a top view on the lower member of an extrusion module on the level E-E in accordance with the arrow D3 shown in FIG. 3;

FIG. 7 is a schematic representation of the arrangement and embodiment of the channel system of an extrusion module;

FIG. 8 shows the section C-C in FIG. 4 through the lower member of an extrusion module in a schematic representation;

FIG. 9 is a top view on the pre-distribution ring in accordance with FIG. 3 in the direction of the arrow D4; and

FIG. 10 shows the cross section F-F taken through the pre-distribution ring in accordance with FIG. 3.

### DESCRIPTION OF PREFERRED EMBODIMENTS

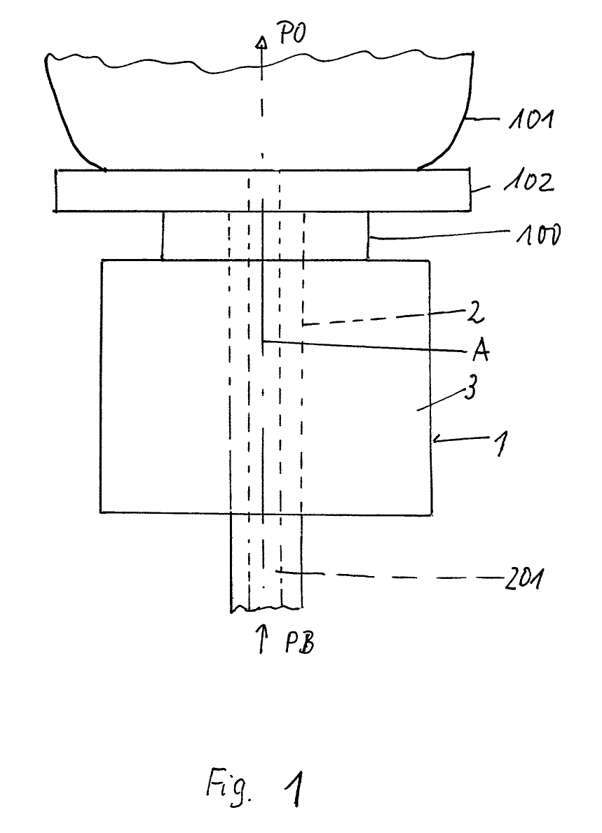

A device for extruding and blowing a multi-layered blown film 101 is schematically shown in parts in FIG. 1. The extrusion device comprises the modularly constructed extrusion head 1 with an extrusion die 100 for the exit of the plastic film in the shape of a tube-shaped strand, which thereafter is blown in the direction PO to form a blown film 101. The extrusion head 1 comprises an interior member 2 of the extrusion head 1, and an exterior member 3 of the extrusion head 1, which are arranged coaxially in relation to the center axis A of the extrusion head 1. A cooling ring 102 surrounding the strand exiting from the extrusion die for the purpose of blowing cooling air against the blown film 101 is arranged ahead of the extrusion die 100. The internal member 2 of the extrusion head is embodied as a mandrel with a cylindrical diameter, for example, and a passage 210 is formed in its interior, which can be used in a manner known for supplying blow air to, and removing it from, the film to be blown, as shown by the arrow PB.

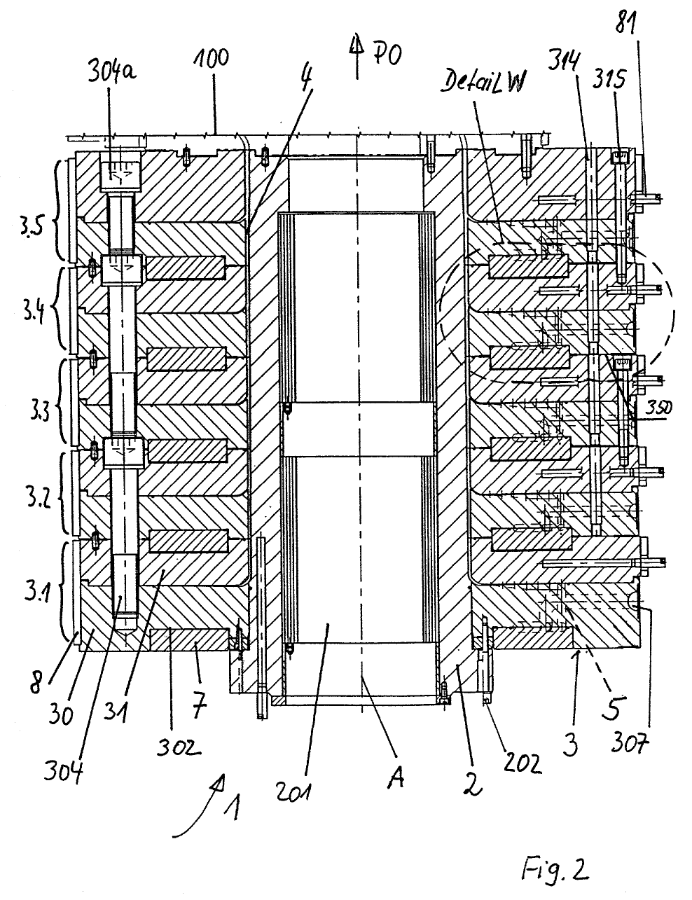

This invention relates to the structure and design of the extrusion head 1, such as shown in FIG. 2, in which the internal member 2 of the extrusion head 1 in the form of the mandrel is surrounded by the external member 3 of the extrusion head 1 while keeping an annular space 4 open, wherein the annular space 4 is oriented coaxially with respect to the center axis A of the extrusion head.

The external member 3 of the extrusion head comprises a number of extrusion modules corresponding to the number of plastic melts which are fed in layers into the annular space 4. Five extrusion modules 3.1, 3.2, 3.3, 3.4, 3.5 are provided in the exemplary embodiment, all of which have basically the same structure and are arranged on top of each other in the manner of a stack. Each extrusion module is essentially divided vertically with respect to the center axis A of the extrusion head and comprises two members 30, 31 of the extrusion module, each of which is embodied to be ring-shaped and plate-shaped, and they are also arranged on top of each other. The member 31 of the extrusion module facing the extrusion die 100 is referred to as the upper member, and the member 30 of the extrusion module facing away from the extrusion die 100 is referred to as the lower member of each extrusion module 3.1 to 3.5. The individual extrusion modules 3.1 to 3.5 are connected with each other with screws 304, or 315, in particular, each extrusion module is connected with the previous extrusion module with respective screws 304. The extrusion members 30, 31 of an extrusion module 3.1 to 3.5 are also connected with each other with screws 314. Only the exteriors of the extrusion members located on the outside of each outer extrusion module of an extrusion head 1, for example the lower member 30 of the first extrusion module 3.1 and the upper member 31 of the extrusion module 3.5, are matched to this end position, wherein these are particularly distinguished by an increased thickness relative to the thickness of the extrusion members of the inner extrusion modules 3.2, 3.3, 3.4.

With an uneven number of extrusion modules, an extrusion module located on the exterior respectively remains which can only be screwed together with a half-length screw 304a, see for example FIG. 2. Thus, the five extrusion modules are alternatingly fastened by means of the large screws 304 on the circumference so that one half-length screw 304a is respectively arranged either in the last extrusion module 3.5 close to the extrusion die, or in the extrusion module 3.1 farthest away from the extrusion nozzle, not shown in FIG. 2.

Each extrusion module 3.5 has an inlet opening 307 on the outside on its circumference, which is used for the connection of a feed line, not represented in the drawings, for thermoplastic melts K. Each extrusion module 3.1 to 3.5 has a channel system 5 for distributing the plastic melt flowing in through the inlet opening 307 for dividing and conveying the same to the annular space 4. The plastic melts are sequentially conveyed, spaced apart in layers, into the annular space 4 at the end of each channel system 5 of each extrusion module, and then exit in the direction of the arrow PO via the extrusion die 100, not represented in the drawings, in the form of a respective multi-layered, in this case five-layered, tube-shaped strand, which thereafter is blown up into the blown film. The individual extrusion modules can be charged with the same and/or with different plastic films.

Each extrusion module 3.1 to 3.5 has individual heating elements, in this case in the form of heating strips 8 applied to the exterior, which allow individually different heating of the individual extrusion modules, depending on the raw materials supplied and on production requirements. Sockets 81 for temperature sensors for monitoring and control are respectively provided in the upper member of the extrusion module, into which appropriate temperature sensors can be inserted.

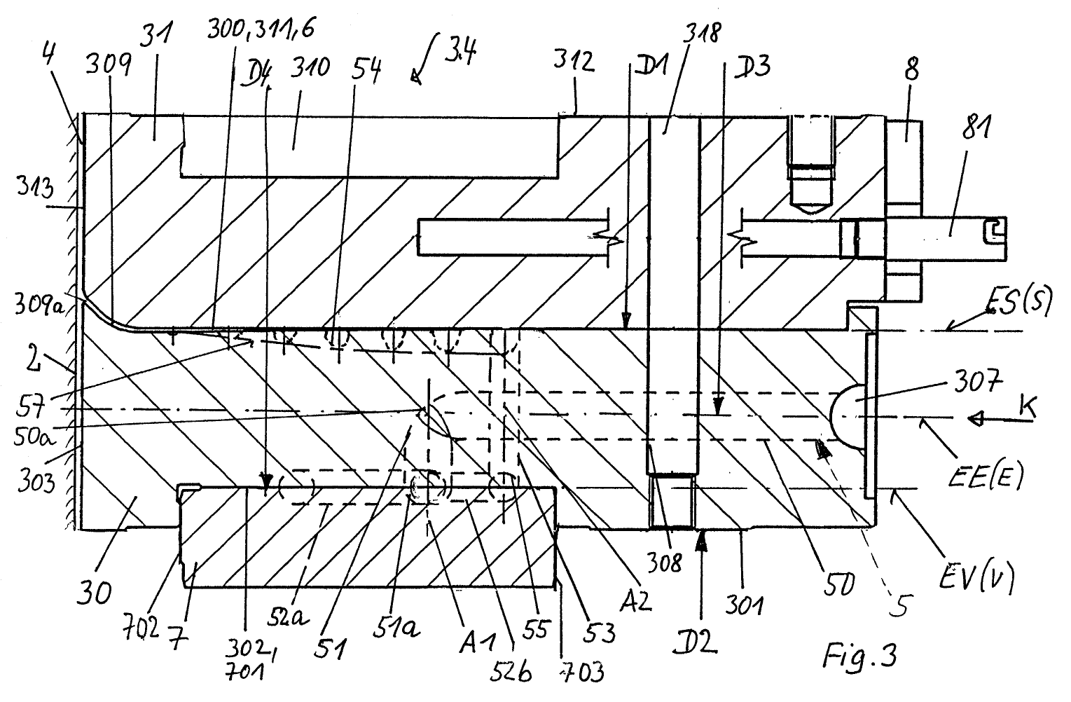

In FIG. 2, the channel system for the melt distribution in each extrusion module is only schematically represented in the right half of the drawing. The further structure of the individual extrusion modules 3.1 to 3.5 and of the channel system, which is essentially the same in each case, is explained in greater detail in what follows by means of the enlarged representation of the inner extrusion module 3.4, here representatively selected, in accordance with the detail D shown in FIG. 2 and FIG. 3. The extrusion module 3.4 in FIG. 3 comprises a first lower member 30 of the extrusion module and a second upper member 31 of the extrusion module, which are ring-shaped and disk-shaped and are arranged placed on top of each other in a stack-like manner, wherein a separating gap 6 is formed between the two members 30, 31 of the extrusion module. The members 30, 31 of the extrusion module are arranged coaxially around the center axis A of the extrusion head 1. Each of the members 30, 31 of the extrusion module has an interior bore 303, or 313, which forms the outer border with the annular space 4.

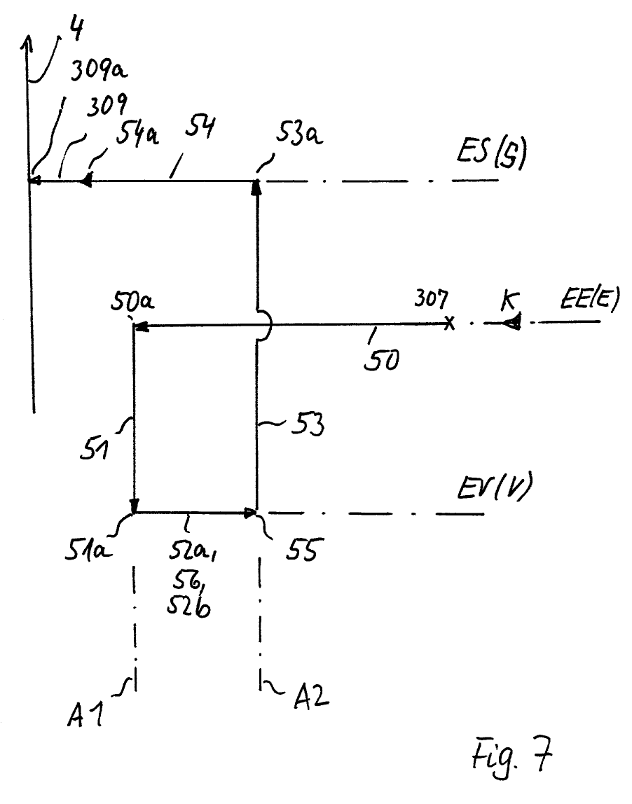

On its circumference, the lower member 30 of the extrusion module has an inlet opening 307, through which the thermoplastic melt K is fed. The thermoplastic melt reaches the channel system 5 and is evenly distributed or conveyed further in it until it reaches the separating gap 6 between the upper and the lower members of the extrusion module, from where it reaches the annular space 4 via a distribution surface 309 with a ring-shaped outlet opening 309a, and is conveyed from there to the extrusion die. The channel system for distributing the plastic melt in an extrusion module, such as explained by FIG. 3, is also schematically shown in FIG. 7. The channel system in accordance with this invention comprises three areas, namely an inlet area E, which extends essentially vertically with respect to the center axis A of the extrusion head from the inlet opening 307 on the level EE within the lower member 30 of the extrusion module, a branching area V, which extends on a level EV, which adjoins the extrusion module located next to it, along the underside 301 of the lower member 30 of the extrusion module, such as on the side of the member 30 of the extrusion module facing away from the extrusion die 100, and a spiral area S, which extends on a level ES, which is located on the level of the separating gap 6. The inlet area E is connected with the branching area V via a group of first connecting channels 51, and the branching area V is connected with the spiral area S via a second group of connecting channels 53. The groups of connecting channels 51, 53 essentially extend vertically with respect to the levels EE, EV, ES of the channel system for distributing melt to the inlet area E, the branching area V and the spiral area S, see the connecting channel axes A1, A2. The connecting channels 51, 53 are preferably arranged coaxially with respect to the center axis A of the extrusion head. Viewed in the flow direction of the plastic melt K, the inlet area, the branching area and the spiral area follow each other. The channel system 5 is on only one of the two members of the extrusion module, namely member 30 of the extrusion module.

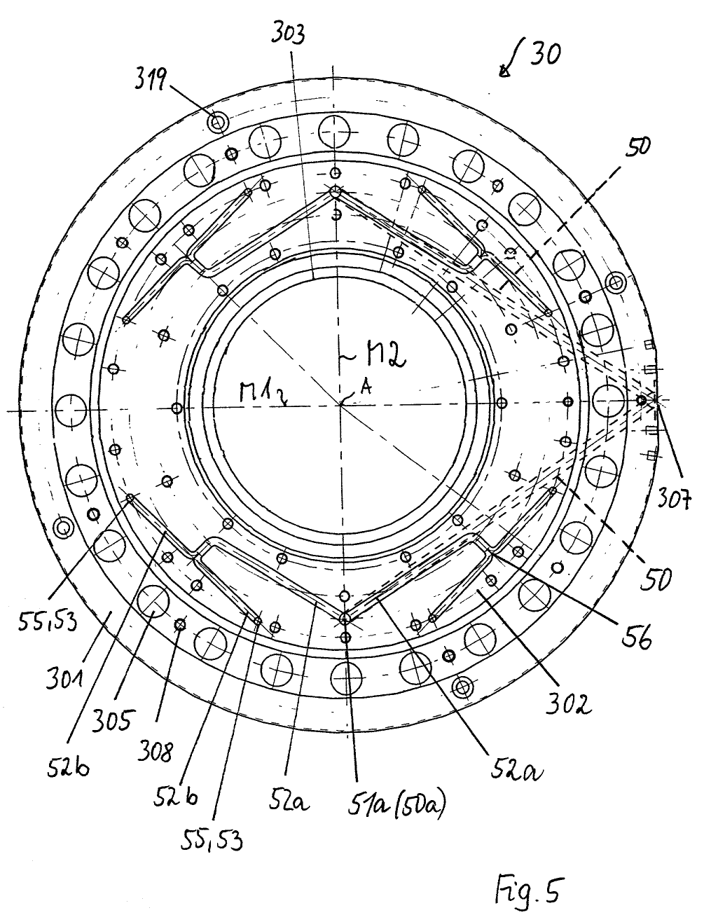

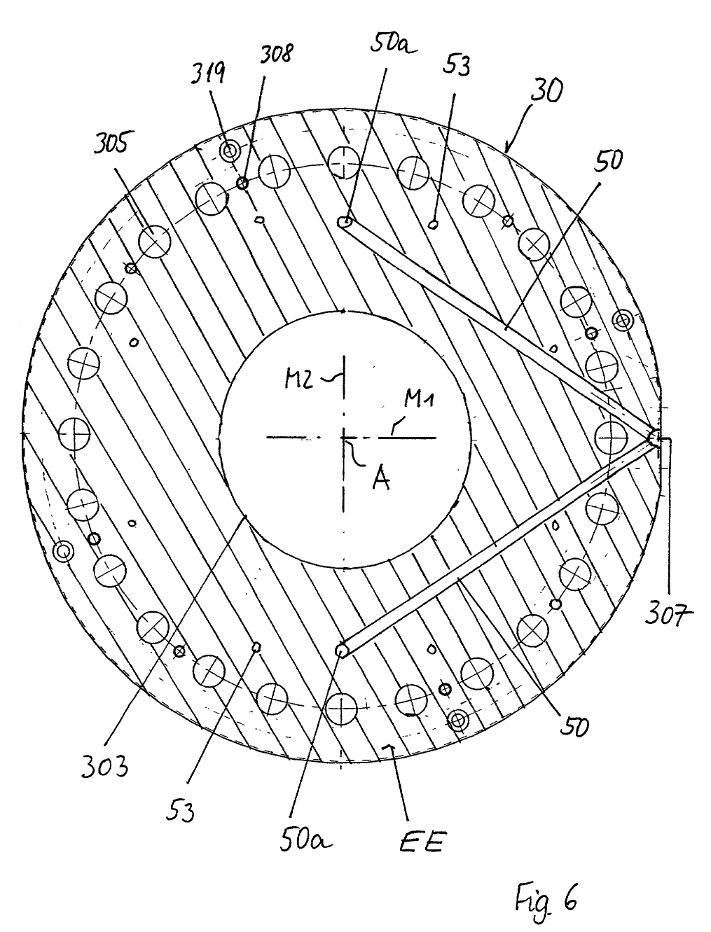

The level EE of the inlet area E extends between the two other levels EV and ES of the branching area V and of the spiral area S, wherein all three levels EE, EV and ES essentially extend parallel with each other, and in the exemplary embodiment the three levels also extend essentially vertically with respect to the center axis A of the extrusion head 1. These individual areas will be explained in view of FIGS. 3 and 7 in a manner analogously to the path of the plastic melt K, starting at the inlet opening 307 at the circumference and as far as the exit in the annular space 4. Initially, the plastic melt K enters the inlet area E of the channel system at the inlet opening 307, wherein the inlet area is formed by two inlet channels, which are arranged in a V-shape in relation to each other and extend from the inlet opening 307 at the circumference of the lower member 30 of the extrusion module, see FIG. 6, and are formed on an inlet level EE within the member 30 of the extrusion module. The two inlet channels 50, which form the inlet area E of the channel system 5, located on the level EE, extend mirror-reversed in relation to the center axis M1, and with the ends 50a terminate at the second center axis M2, which extends at right angles to the first. As shown in FIG. 3, each end 50a of the two inlet channels 50 terminates in a connecting channel 51 constituting the first group of connecting channels. The connecting channels 51 lead from the level EE of the inlet area E to the underside 301 of the member 30 of the extrusion module and thus to the branching area V, as also shown in the view of the underside 301 of the member 30 of the extrusion module in accordance with FIG. 5. The connecting channels 51 end in the area 51a in the branching channels 52a of the branching area V, which start at this location.

A circumferential annular groove 302 is cut into the underside 301 of the member 30 of the extrusion module having the channel system 5, see for example FIG. 3, into which a pre-distribution ring 7 is inserted, with two lateral faces 702 and 703 fittingly and sealingly received in the annular groove 302. However, the pre-distribution ring 7 has a greater height than would correspond to the depth of the annular groove 302, and it therefore projects by a corresponding portion of its cross section past the surface 301 of the member 30 of the extrusion module. At the same time, the surface 301 of the member 30 of the extrusion module forms the separating gap and the contact face for the adjoining next extrusion module 3.3, see FIG. 2, and its upper member of the extrusion module. The separating gap 301 is pulled into the member 30 of the extrusion module because of the design of the annular groove 302, and in accordance with the invention the branching area V with the channel system 52a, 52b is formed in the surface of the groove bottom of the annular groove 302. Starting at each end 51a of a connecting channel 51, a branching system 52a, 52b is formed in the groove bottom 302 on the underside 301 of the member 30 of the extrusion module. These two branching systems are arranged symmetrically with respect to the center axis Ml of the extrusion module, see for example FIG. 5. Starting at the ends 51a of the connecting channels 51, each branching system is designed symmetrically with respect to the center axis M2, which runs vertically relative to the center axis M1, and respectively has two branching channels 52a, which depart in a V-shape, extend radially inward, are angled at their end points 56 and again branch into respectively two channel sections 52b extending radially outward. The channel sections 52b terminate in eight end points 55, which are arranged in a circle around the center axis A of the extrusion head at even distances from each other. Thus, the flow path of the plastic melt is symmetrically divided, starting at the inlet area, via the channels 50 to the end points 55 of the branching area, and all flow paths are of the same length from the inlet opening 307 to the point 55.

It is possible to cut the required flow cross section of the branching area V completely into the surface 301 of the member 30 of the extrusion module. But it is also possible to cut one half of this required flow cross section of the branching channels in the branching area V into the surface of the member 30 of the extrusion module, and the other half into the surface of the adjoining pre-distribution ring 7. Because of the design of the annular groove 302, the branching area V is moved out of the immediate separating gap between adjoining extrusion modules, and perfect sealing of the branching area V becomes possible.

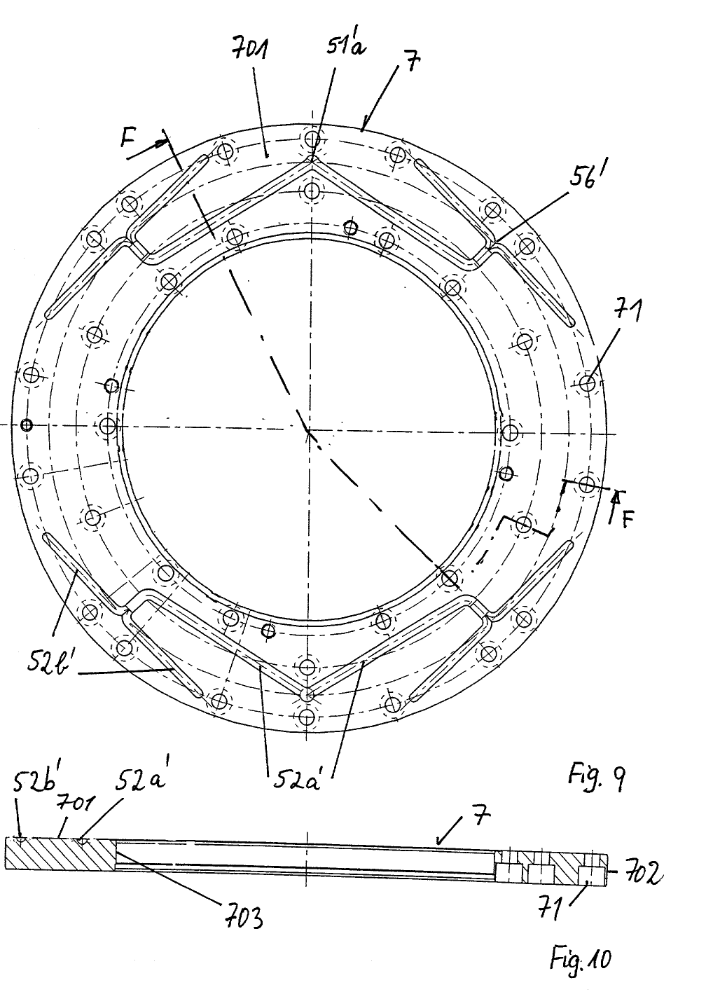

A mirror-reversed channel system 52a′, 52b′, 56′ is formed, for example in the form of groove-like milled areas, see for example FIGS. 9 and 10, in the surface 701 of the pre-distribution ring 7 facing the annular groove 302 in an arrangement identical to the channel system 52a, 52b cut into the underside 301 in the area of the annular groove 302 of the member 30 of the extrusion module.

For example, it is possible to see in FIG. 3, in connection with FIG. 9, that respectively one half of the flow cross section 52a, 52b, 56 of the path and the flow cross section of all branching channels of the branching area V is formed on the first member 30 of the extrusion module, and the other half 52a′, 52b′, 56′ on the pre-distribution ring 7. In accordance with this invention, the provision of the annular groove 302 on the member 30 of the extrusion module, along with the pre-distribution ring 7 inserted therein, makes it possible to take the center one of the three distribution areas including the inlet area, the branching area and the spiral area, namely the branching area, out of the connecting gap 350, see FIG. 2, adjoining the underside 301 of the member 30 of a first extrusion module, for example extension module 3.4, of the adjoining extrusion module 3.3, or its adjoining second member 31 of the extrusion module, and to displace it into the area of the annular groove 302. Thus it is possible to seal the branching area perfectly in the area of the annular groove 302/pre-distribution ring 7.

The pre-distribution ring 7 can be arranged and fastened with screws, not shown, inserted through bores 71, also see FIG. 10, inside the annular groove 302 of the first member 30 of the extrusion module so that the milled areas 52a, 52b, 52a′, 52b′, which form the branching channels 52, come to rest on each other in a corresponding manner and form a branching area of channels with circular cross section.

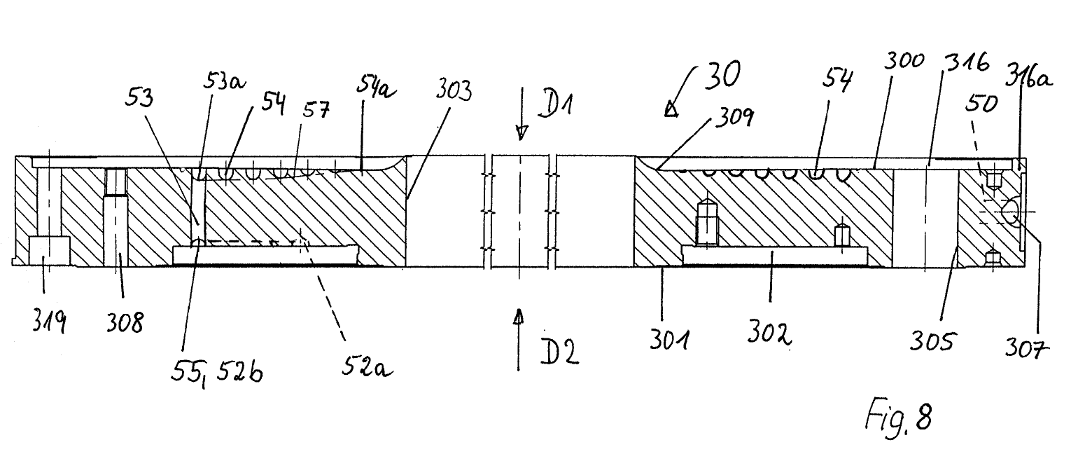

Respective connecting channels 53, which form the second group of connecting channels, adjoin the eight ends 56 of the channel sections 52b, which form the branching area and are embodied on the underside of the first member 30 of the extrusion module in the area of the groove bottom of the annular groove 302, see FIG. 8 and FIG. 3.

Starting on the level EV of the branching area, these second connecting channels 53 lead, essentially axis-parallel with respect to the longitudinal axis A of the extrusion head, or of the extrusion modules, through the lower member 30 of the extrusion module up to the top 300 of the lower member 30 of the extrusion module, for example as far as the separating gap 6 between the lower and the upper members of the extrusion module. During this the connecting channels 53 penetrate through the level EE of the inlet area, but in areas outside of the formed inlet channels 50.

The arrangement of the second connecting channels 53 is selected so that they are all located on a common circle extending coaxially with respect to the annular space 4, and that respectively adjoining connecting channels 53 are at the same distance from each other on the circle. This geometry is already prescribed by the arrangement of the branching channels and the ends 55 of the channel sections 52b. The third distribution area, namely the spiral area S in the form of groove-like milled areas arranged in a spiral, is formed on the top 300 of the lower member 30 of the extrusion module, which is the surface of the member 30 of the extrusion module leading in the blowing direction PO of the underside 301.

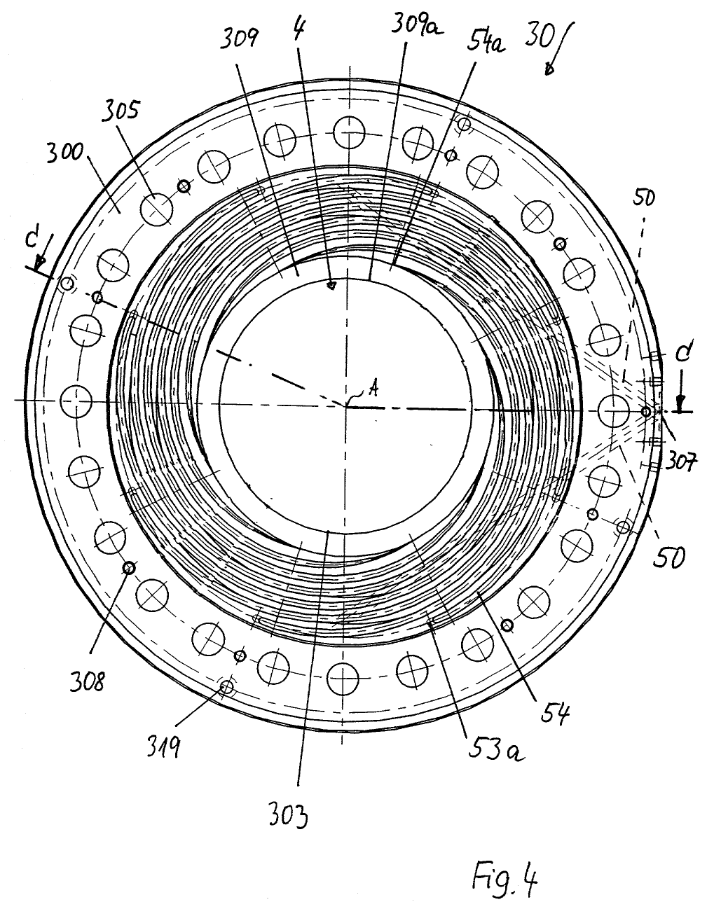

On the top 300 of the lower member 30 of the extrusion module represented in FIG. 4, spiral channels 54 extend from each end 53a of the total of eight connecting channels 53 which end here, and are conducted, located next to each other and converging, in the direction toward the interior bore 303 and the annular space 4. The spiral channels are located on a level ES and form the spiral area S of the channel system. A ring-shaped pre-distribution face 309 which, together with the separating gap 6 between the upper and the lower members 31, 30 of the extrusion module forms a flow gap, is formed between the ends 54a of the spiral channels, see FIG. 3 and FIG. 4, and the annular space 4. In the direction toward the annular space 4, the partial flows of the supplied plastic melt exiting from the ends 53a of the connecting channels 53 now reach the ring-shaped pre-distribution face 309 formed on the top 300 over spiral-shaped paths within the individual spiral channels 54, from where they enter the circumferential annular space 4 of the extrusion head 1 via the gap 309a.

Because of the spiral-shaped arrangement of the individual spiral channels 54, an even division of the individual partial flows into a homogeneous total flow is achieved, which enters into the annular space 4 radially over the distribution face 309.

The level ES of the spiral area borders on the separating gap 6 formed between the lower member 30 and the upper member 31 of each extrusion module, for example the extrusion module 3.4. The spiral area is covered on the top of the member 30 of the extrusion module by the second member 31 of the extrusion module. In this case the ring-shaped distribution surface 309, which adjoins the end of the spiral channels toward the annular space 4, is embodied as the outlet opening 309a.

The plastic melt entering the extrusion module through the inlet opening 307 thus undergoes a repeated division inside the channel system 5 in that first it enters the branching area V located below the level EE on a level EV from the inlet level EE arranged inside the lower member 30 of the extrusion module and their inlet channels 50 through first connecting channels 51 formed on the ends 50a of the latter. Within this branching area V, the plastic melt K is divided in the branching channels 52a, 52b, 56 into further partial flows, here a total of eight, which then reach the spiral area S, whose level ES is arranged above the level EE of the inlet area E, via the second connecting channels 53 and through the lower member 30 of the extrusion module. Finally, the plastic melt is conducted via the individual spiral channels 54 forming the spiral area S to the ring-shaped outlet opening 309a, from which it enters the annular space 4 as a homogeneous tube-shaped flow.

The individual spiral channels having a decreasing flow cross section toward their end 54a, for example toward the distribution surface 309, in that the inside width, depth of the grooves, which are cut into the surface of the member of the extrusion module in the form of spiral channels, of the individual spiral channels 54 is continuously reduced, see the path of the depth lines 57 in FIGS. 2 and 8, also aids in the homogenization of the outflow of the melt from the outlet opening 309a.

It is important for good homogenization that all paths in the above explained channel system 5 through which the plastic melt runs have the same length, so that an even effect on the plastic melt regarding pressure and heat is provided.

Based on the fact that the entire channel system 5 is symmetrically divided into respectively an inlet area, a branching area and a spiral area, which are arranged on three different levels EE, EV, ES in a member 30 of an extrusion module, not only is a particularly even distribution of the plastic melt achieved, but this type of distribution also only requires a surprisingly low structural height of the extrusion modules, and therefore of the extrusion head, which results in an advantageously low total height of the extrusion head explained above. Of the two members 30, 31 of an extrusion module, only one member of the extrusion module, namely the lower member 30, is embodied with channels for the melt supply.

It can be seen from the drawings that all levels EE, EV, ES of the inlet, branching, or spiral areas extend parallel with respect to each other and vertically in relation to the longitudinal axis A of the extrusion head 1. The first and second connecting channels 51, 53 themselves extend parallel with respect to each other and vertically in relation to the levels EE, EV and ES.

However, this geometry is only shown by way of example, orientations of the levels EE, EV and ES and/or the connecting channels 51, 53 deviating from this are also conceivable.

A particularly efficient construction of the extrusion head is assured because a large number of identical parts is employed, which can be clearly perceived in FIG. 1, in which it can be seen that the extrusion modules 3.2, 3.3 and 3.4 have almost identical members, and the lowest and highest extrusion modules 3. 1, or 3.5, have only slightly changed dimensions in comparison. Otherwise the interior bore diameters of the extrusion modules change and become larger in the direction toward the extrusion die in each extrusion module in accordance with the layer thickness to be applied per module.

For achieving a particularly compact and space-saving construction, for several extrusion models, such as shown in FIG. 1, the pre-distribution ring 7, which is a part of the respectively lower member 30 of an extrusion module and which, as already mentioned, projects beyond the underside 301 of the first member 30 of the extrusion module, is received with its protruding cross sectional area in a complementarily designed annular groove 310 on the top 312 of the upper member 31 of the previous extrusion module, so that a particularly stable seating and space-saving construction is achieved, see FIGS. 2 and 3.

The bores 308,318,319, 305 are shown in FIGS. 3, 4, 5, 6, 8 and 9, and are used for receiving the screws 314, 315, 304, 304a for screwing the members of the extrusion modules, or the extrusion modules themselves, together.

The internal member of the extrusion head embodied as an interior mandrel 2 is also fastened by means of screws 202 on the member of the first extrusion module 3.1 located on the outside.

Since moreover, based on the previously explained melt distribution system of each extrusion module 3.1 to 3.5, an effective melt distribution on short paths takes place, the individually supplied thermoplastic melts remain unaffected to a large extent by the different temperatures of other extrusion modules, which results in a high accuracy of the production.

What is claimed is:

1. In an extrusion head with an extrusion die (100) for extruding a tube-shaped strand from at least one thermoplastic melt (K) for producing blown films (101), wherein the extrusion head (1) has an internal member (2) arranged around a center axis (A) and an external member (3), and wherein an annular space (4) is formed between the internal member (2) and the external member (3), and wherein the annular space (4) extends concentrically with respect to the center axis (A) and terminates in the extrusion die (100), and wherein the external member (3) has at least one extrusion module (3.1, 3.2, 3.3, 3.4) with two extrusion members (30, 31), arranged on top of each other and ring-shaped and plate-shaped, and wherein a separating gap (6) which terminates in the annular space (4) is formed between the two extrusion members (30, 31) of each extrusion module (3.1, 3.2, 3.3, 3.4) and wherein each extrusion module (3.1, 3.2, 3.3, 3.4) has a feed line for a plastic melt (K) and a channel system (5) for distributing the plastic melt (K) as far as into the annular space (4) is formed in each extrusion module (3.1, 3.2, 3.3, 3.4), the improvement comprising:
the channel system (5) of each extrusion module (3.1, 3.2, 3.3, 3.4) having an inlet area (E), a branching area (V) and a spiral area (S), the spiral area (S) terminating into the annular space (4) in a ring-shaped distribution surface (309) with a ring-shaped outlet opening (309a), the inlet area (E), the branching area (V) and the spiral area (S) of the channel system (5) each extending on a separate level, a first level (EE) of the inlet area (E) extending between a second level (EV) of the branching area (V) and a third level (ES) of the spiral area (S), and the channel system of the inlet area (E) connected with the channel system of the branching area (V) by a first group of connecting channels (51) which lead from the first level (EE) of the inlet area to the second level (EV) of the branching area, and the channel system of the branching area (V) connected with the channel system of the spiral area (S) by a second group of connecting channels (53) leading from the second level (EV) of the branching area (V) to the third level (ES) of the spiral area (S).

2. In the extrusion head in accordance with claim 1, wherein the inlet area (E) of the channel system, the branching area (V) of the channel system, and the spiral area (S) of the channel system of an extrusion module extend on the first, second and third levels (EE, EV, ES) which are arranged parallel with each other.

3. In the extrusion head in accordance with claim 2, wherein the first, second and third levels (EE, EV, ES) of the inlet area (E), the branching area (V) and the spiral area (S) are arranged so that they extend vertically relative to the center axis (A) of the extrusion head (1).

4. In the extrusion head in accordance with claim 3, wherein the first group of connecting channels (51) which connect the inlet area (E) of the channel system with the branching area (V) of the channel system, and the second group of connecting channels (53) which connect the branching area (V) of the channel system with the spiral area (S) of the channel system extend vertically with respect to the first, second and third levels (EE, EV, ES) of the inlet area (E), the branching area (V) and the spiral area (S) of the channel system, as well as coaxially with respect to the center axis (A) of the extrusion head (1).

5. In the extrusion head in accordance with claim 4, wherein the channel system (5) comprising the inlet area (E), the branching area (V) and the spiral area (S) and the groups of connecting channels (51, 53) is embodied in one of the two extrusion members (30, 31) of each extrusion module (3.1, 3.2, 3.3, 3.4).

6. In the extrusion head in accordance with claim 5, wherein the channel system (5) comprising the inlet area (E), the branching area (V) and the spiral area (S) and the groups of connecting channels (51, 53) is formed in the member of one of the extrusion modules which faces away from the extrusion die (100), identified as the lower member (30) of the extrusion module, and the second member of one of the extrusion modules, identified as the upper member (31) of the extrusion module, of each extrusion module (3.1, 3.2, 3.3, 3.4) is placed on a top of the surface (300) embodied with the spiral area (S) of the lower member (30) of the extrusion module and forms the separating gap (6).

7. In the extrusion head in accordance with claim 6, wherein the spiral area (S) of the channel system is formed in a surface (300) of the lower member (30) of the extrusion module facing the separating gap (6), the branching area (V) of the channel system is formed in an oppositely located surface (301) of the lower member (30) of the extrusion module facing away from the separating gap (6), and the entry area (E) of the channel system is formed between the two surfaces (300, 301) within the lower member (30) of the extrusion module.

8. In the extrusion head in accordance with claim 7, wherein the channel system of the spiral area (S) is formed of spiral channels (54), and the channel system of the branching area (V) is formed of branching channels (52a, 52b) which branch out, and at least one of the spiral channels (54) and the branching channels (52a, 52b) are cut as grooves into the two surfaces (300, or 301) of the lower member (30) of the extrusion module.

9. In the extrusion head in accordance with claim 8, wherein the lower member (30) of the extrusion module of each extrusion module (3.1, 3.2, 3.3, 3.4), which has the channel system (5), is embodied on the surface (301) located opposite the surface (300) having the spiral channels (54), with a circumferential annular groove (302) forming a groove bottom, and a pre-distribution ring (7) is insertable into the annular groove (302), wherein the pre-distribution ring (7) has a surface (701) resting on the groove bottom of the annular groove (302), and the branching area (V) is embodied on the surface (301) of the member (30) of the extrusion module near the groove bottom of the annular groove (302).

10. In the extrusion head in accordance with claim 9, wherein the branching channels forming the branching area (V) have a cross section, wherein a portion of the cross section (52a, 52b) is embodied in the surface (301) of the lower member (30) of the extrusion module near the groove bottom of the annular groove (302), and a complementary portion of the cross section (52a′, 52b′) is embodied on the surface (701) of the pre-distribution ring (7) near the groove bottom (302) of the lower member (30) of the extrusion module.

11. In the extrusion head in accordance with claim 10, wherein the pre-distribution ring (7) has a greater thickness than a depth of the annular groove (302) of the lower member (30) so that the pre-distribution ring (7) projects with a portion of its cross section past the annular groove (302) in the direction toward the adjoining extrusion module, and the projecting portion of the pre-distribution ring (7) is fitted into a complementarily designed annular groove in a top (312) of the upper member (31) of an adjoining following extrusion module (3.1, 3.2, 3.3, 3.4).

12. In the extrusion head in accordance with claim 11, wherein the entry area (E) of the channel system has two inlet channels (50) arranged in a V-shape relative to each other and extend from an inlet opening (307) at the circumference of the lower member (30) and terminate opposite each other and are centered with respect to the central axis (A), and which communicate at the two ends (50a) of the inlet channels with each one of a connecting channel (51) leading to the branching area (V).

13. In the extrusion head in accordance with claim 12, wherein in the branching area (V) two branching systems are formed symmetrically with respect to each other, starting at the two connecting channels (51) emanating from the inlet channels (50), and each of the branching systems again branches into four identical branching channels (52), and eight ends (55) of the branching channels (52) are evenly distributed on a circular ring coaxially to the center axis (A), and respectively communicate with a connecting channel (53) leading to the spiral area (S).

14. In the extrusion head in accordance with claim 13, wherein the spiral area (S) comprises the spiral channels (54) placed inside each other and extending inward in a converging manner toward the annular space (4) and communicate at radially outside located ends with one of the connecting channels (53) coming from the branching area (V), and the spiral channels (54) have a cross section decreasing from an outside toward an inside.

15. In the extrusion head in accordance with claim 14, wherein all flow paths for the plastic melt (K) through the channel system (5) in one of the at least one extrusion module (3.1, 3.2, 3.3, 3.4) are of equal length from the inlet opening (307) to the outlet opening (309a) into the annular space (4).

16. In the extrusion head in accordance with claim 15, wherein the at least one extrusion module (3.1, 3.2, 3.3, 3.4) can be separately heated.

17. In the extrusion head in accordance with claim 1, wherein the first, second and third levels (EE, EV, ES) of the inlet area (E), the branching area (V) and the spiral area (S) are arranged so that they extend vertically relative to the center axis (A) of the extrusion head (1).

18. In the extrusion head in accordance with claim 1, wherein the first group of connecting channels (51) which connect the inlet area (E) of the channel system with the branching area (V) of the channel system, and the second group of connecting channels (53) which connect the branching area (V) of the channel system with the spiral area (S) of the channel system extend vertically with respect to the first, second and third levels (EE, EV, ES) of the inlet area (E), the branching area (V) and the spiral area (S) of the channel system, as well as coaxially with respect to the center axis (A) of the extrusion head (1).

19. In the extrusion head in accordance with claim 1, wherein the channel system (5) comprising the inlet area (E), the branching area (V) and the spiral area (S) and the groups of connecting channels (51, 53) is embodied in one of the two extrusion members (30, 31) of each extrusion module (3.1, 3.2, 3.3, 3.4).

20. In the extrusion head in accordance with claim 1, wherein the channel system (5) comprising the inlet area (E), the branching area (V) and the spiral area (S) and the groups of connecting channels (51, 53) is formed in the member of one of the extrusion modules which faces away from the extrusion die (100), identified as the lower member (30) of the extrusion module, and the second member of one of the extrusion modules, identified as the upper member (31) of the extrusion module, of each extrusion module (3.1, 3.2, 3.3, 3.4) is placed on a top of the surface (300) embodied with the spiral area (S) of the lower member (30) of the extrusion module and forms the separating gap (6).

21. In the extrusion head in accordance with claim 1, wherein the spiral area (S) of the channel system is formed in a surface (300) of the lower member (30) of the extrusion module facing the separating gap (6), the branching area (V) of the channel system is formed in an oppositely located surface (301) of the lower member (30) of the extrusion module facing away from the separating gap (6), and the entry area (E) of the channel system is formed between the two surfaces (300, 301) within the lower member (30) of the extrusion module.

22. In the extrusion head in accordance with claim 1, wherein the channel system of the spiral area (S) is formed of spiral channels (54), and the channel system of the branching area (V) is formed of branching channels (52a, 52b) which branch out, and at least one of the spiral channels (54) and the branching channels (52a, 52b) are cut as grooves into two surfaces (300, or 301) of the lower member (30) of the extrusion module.

23. In the extrusion head in accordance with claim 1, wherein the lower member (30) of the extrusion module of each extrusion module (3.1, 3.2, 3.3, 3.4), which has the channel system (5), is embodied on a surface (301) located opposite another surface (300) having the spiral channels (54), with a circumferential annular groove (302) forming a groove bottom, and a pre-distribution ring (7) is insertable into the annular groove (302), wherein the pre-distribution ring (7) has a surface (701) resting on the groove bottom of the annular groove (302), and the branching area (V) is embodied on the surface (301) of the member (30) of the extrusion module near the groove bottom of the annular groove (302).

24. In the extrusion head in accordance with claim 23, wherein the branching channels forming the branching area (V) have a cross section, wherein a portion of the cross section (52a, 52b) is embodied in the surface (301) of the lower member (30) of the extrusion module near the groove bottom of the annular groove (302), and a complementary portion of the cross section (52a′, 52b′) is embodied on the surface (701) of the pre-distribution ring (7) near the groove bottom (302) of the lower member (30) of the extrusion module.

25. In the extrusion head in accordance with claim 9, wherein the pre-distribution ring (7) has a greater thickness than a depth of the annular groove (302) of the lower member (30) so that the pre-distribution ring (7) projects with a portion of its cross section past the annular groove (302) in the direction toward the adjoining extrusion module, and the projecting portion of the pre-distribution ring (7) is fitted into a complementarily designed annular groove in a top (312) of the upper member (31) of an adjoining following extrusion module (3.1, 3.2, 3.3, 3.4).

26. In the extrusion head in accordance with claim 1, wherein the entry area (E) of the channel system has two inlet channels (50) arranged in a V-shape relative to each other and extend from an inlet opening (307) at the circumference of the lower member (30) and terminate opposite each other and are centered with respect to the central axis (A), and which communicate at the two ends (50a) of the inlet channels with each one of a connecting channel (51) leading to the branching area (V).

27. In the extrusion head in accordance with claim 1, wherein in the branching area (V) two branching systems are formed symmetrically with respect to each other, starting at the two connecting channels (51) emanating from the inlet channels (50), and each of the branching systems again branches into four identical branching channels (52), and eight ends (55) of the branching channels (52) are evenly distributed on a circular ring coaxially to the center axis (A), and respectively communicate with a connecting channel (53) leading to the spiral area (S).

28. In the extrusion head in accordance with claim 1, wherein the spiral area (S) comprises the spiral channels (54) placed inside each other and extending inward in a converging manner toward the annular space (4) and communicate at radially outside located ends with one of the connecting channels (53) coming from the branching area (V), and the spiral channels (54) have a cross section decreasing from an outside toward an inside.

29. In the extrusion head in accordance with claim 1, wherein all flow paths for the plastic melt (K) through the channel system (5) in one of the at least one extrusion module (3.1, 3.2, 3.3, 3.4) are of equal length from the inlet opening (307) to the outlet opening (309a) into the annular space (4).

30. In the extrusion head in accordance with claim 1, wherein the at least one extrusion module (3.1, 3.2, 3.3, 3.4) can be separately heated.
